(19) United States
(12) Patent Application Publication
(10) Pub. No.: US 2011/0051599 A1
(43) Pub. Date: Mar. 3, 2011

(54) Radio Communication System, Base Station Device, Radio Communication Terminal, and Radio Communication Method

(75) Inventors: Hironobu Tanigawa, Kanagawa (JP); Yasuhiro Nakamura, Kanagawa (JP); Toru Sahara, Kanagawa (JP); Nobuaki Takamatsu, Kanagawa (JP)

(73) Assignee: KYOCERA CORPORATION, Kyoto-shi, Kyoto (JP)

(21) Appl. No.: 12/439,816

(22) PCT Filed: Sep. 4, 2007
(86) PCT No.: PCT/JP2007/067190

§ 371 Date: Nov. 15, 2010

(30) Foreign Application Priority Data
Sep. 8, 2006 (JP) 2006-244235
Sep. 8, 2006 (JP) 2006-244236

(51) Int. Cl. G06F 11/07

(52) U.S. Cl. 370/225

(57) ABSTRACT

A wireless communication system which performs packet communication in a time division multiplexing communication format between wireless communication devices using either one or a plurality of communication channels includes: a resend request unit which detects that a received packet contains an error and requests a resend; a resend request detection unit which detects the request for a resend; a packet resend unit which resends the packet in accordance with the request for a resend detected by the resend request detection unit; and a channel allocation unit which allocates a different communication channel for the packet resend unit to resend the packet from the communication channel which was used for sending the packet in which the error detected by the resend request unit was contained.

### TECHNICAL FIELD

The present invention relates to a wireless communication system, a base station apparatus, a wireless communication terminal, and a wireless communication method.

Priority is claimed on Japanese Patent Application Nos. 2006-244235 and 2006-244236, filed Sep. 8, 2006, the contents of which are incorporated herein by reference.

### BACKGROUND ART

In recent years, wireless communication systems which perform packet communication by employing. OFDMA (Orthogonal Frequency Division Multiple Access) in addition to. TDMA (Time Division Multiple Access)/TDD (Time Division Duplex) systems for multiple access connection technology are receiving attention as next-generation broadband mobile communication systems.

In this type of next-generation broadband mobile communication system, in order for a high communication speed to be maintained, it is common for H-ARQ (Hybrid—Automatic Repeat request) to be employed as an automatic resend control system which efficiently compensates packet errors occurring in wireless space after a short control delay time. A description is given below of operations of a base station and wireless communication terminal relating to this H-ARQ. Note that in the description given below, the base station is taken as the transmitting side while the wireless communication terminal is taken as the receiving side. In addition, in the description given below, a packet synthesis Type 1 method (i.e., a Chase synthesis method) is used as an example of H-ARQ.

Firstly, the wireless communication terminal performs error correction decoding processing on received packets received from the base station, and then, based on CRC (Cyclic Redundancy Check) code attached to the received packet, performs error detection on the received packet. Here, if an error is detected in the received packet, the wireless communication terminal stores the received packet in which the error was detected in an internally provided reception buffer, and then sends a repeat request signal (NACK: Negative ACKnowledgment) to the base station via a control channel. When the base station receives this NACK signal, it resends the packet whose resending was requested (namely, a packet which is the same as the received packet in which the error was detected) to the wireless communication terminal at a predetermined timing.

Next, the wireless communication terminal receives the resent packet, and performs maximum ratio synthesis on the resent packet and on the previous received packet stored in the reception buffer (i.e., the packet in which the error was detected). After the wireless communication terminal has preformed error correction decoding processing on this maximum ratio synthesized resent packet, it detects errors using CRC code in the same way as is described above. Here, if an error is again detected in the resent packet as well, then the same processing as that described above is again performed between the wireless communication terminal and the base station. Specifically, when an error is again detected in a resent packet, the wireless communication terminal generates maximum ratio synthesis data for the initially received packet and the first resent packet, and stores this in the reception buffer. Furthermore, when the wireless communication terminal receives a second resent packet, it performs maximum ratio synthesis on the aforementioned maximum ratio synthesis data and on the second resent packet. Note that if the wireless communication terminal does not detect a CRC code error in a received packet or resent packet, then it sends an ACK (ACKnowledgment) signal to the base station using a control channel. When the base station receives this ACK signal, it sends the next packet to the wireless communication terminal.

As is described above, according to H-ARQ, it is possible to obtain a high-gain reception signal in order to perform maximum ratio synthesis between an earlier received packet in which an error was detected and a resend packet. Furthermore, as a result of this, because there is an improvement in the SINR (Signal to Interference and Noise Ratio) of the reception signal, it is possible to effectively compensate a packet error.

The above described H-ARQ is a function provided mainly in a physical layer. Furthermore, MAC-ARQ such as a stop-and-wait method, a go-back-N method, and a selective-repeat method are available as automatic resend control methods which are provided in a MAC (Media Access Control) layer.

In this MAC-ARQ stop-and-wait method, each time the transmitting side sends one packet, the receiving side receives a NACK signal or an ACK signal. When the receiving side receives a NACK signal, it resends the previously sent packet. When the. transmitting side receives an ACK signal, it sends the next packet.

A go-back-N method is a method in which the transmitting side continuously sends N number of packets, and when it receives a resend request (i.e., a NACK signal) from the receiving side, it resends the packet whose resending was requested as well as all of those packets subsequent to the packet whose resending was requested. A selective-repeat method is a method in which the transmitting side continuously sends N number of packets, and when it receives a resend request (i.e., a NACK signal) from the receiving side, it resends only the packet whose resending was requested.

Note that Patent document 1 discloses conventional technology relating to the above described communication methods.
[Patent document 1] Japanese Patent Application Laid-Open (JP-A) No. 2003-319464

However, in resend control which is based on the above described H-ARQ, maximum ratio synthesis of a packet in which a CRC error was detected and of a resend packet is performed on the receiving side. Because of this, it is necessary for the transmitting side to send a resend packet using a modulation system having the same frequency bandwidth as that used for the previously sent packet, and having the same transmission rate as that used for the previously sent packet.

However, in a multi-carrier communication system such as OFDMA, the base station is provided with a function of adaptively allocating the frequency band and modulation system and the like which are allocated to the wireless communication terminal in accordance with the. QoS (Quality Of Service) and the communication quality. In eases such as this, because a plurality of wireless communication terminals share the frequency band, it cannot be guaranteed that the same frequency bandwidth as that used for the packet which was sent previously will be available when the resend packet is sent (the modulation system can be optionally allocated). Accordingly, there may be cases in which the transmitting side must send a resend packet using a different frequency bandwidth from the frequency bandwidth which was used when the first packet was sent. In cases such as this, the problem arises that H-ARQ does not function normally.

The present invention was conceived in view of the above described circumstances, and it is an object thereof to enable an H-ARQ to function normally even when a frequency band is shared by a plurality of wireless communication terminals.

Furthermore, as is described above, in H-ARQ, it is possible to obtain a high-gain reception signal during resending. Because of this, in H-ARQ, it is possible to use a modulation format having a comparatively high transmission rate, which enables the transmission rate to be increased to its maximum limit. Furthermore, in H-ARQ, redundancy is suppressed by allocating a data bit number which shows whether or not a NACK signal or an ACK signal is contained within the control signal to a single bit portion of a frame header. As a result, in H-ARQ, a payload portion is secured and an improvement in throughput is achieved. However, the data bit which shows whether this signal is a NACK signal or an ACK signal is not data which is subject to CRC.

However, typically, if the communication quality in a control channel deteriorates because of a worsening in the communication environment, there is a possibility that each data bit will be inverted. As is described above, when H-ARQ is employed, there is only 1 data bit which shows whether or not a signal is a NACK signal or an ACK signal. If this data bit becomes inverted because of a worsening in the communication environment, then irrespective of the fact that the receiving side may have sent a NACK signal, it is possible that this may be misinterpreted by the transmitting side as being an ACK signal. In this case, because the transmitting side does not resend the previous packet but instead sends the next packet, the problem arises that a packet error occurs. Moreover, conversely, it is also possible that the transmitting side may misinterpret an ACK signal as being a NACK signal, in which case an unnecessary resending occurs.

The present invention was conceived in view of the above described circumstances, and it is an object thereof to prevent the occurrence of packet errors or of unnecessary resending in packet communication between a base station and a wireless communication terminal. Accordingly, it is an object of the present invention to perform resending control in which any reduction in throughput in packet communication is kept to an absolute minimum.

### DISCLOSURE OF THE INVENTION

In order to solve the above described problems, the present invention may be provided, for example, with the following aspects.

The first aspect of the present invention is a wireless communication system which performs packet communication in a time division multiplexing communication format between wireless communication devices using either one or a plurality of communication channels, and includes: a resend request unit which detects that a received packet contains an error and requests a resend; a resend request detection unit which detects the request for a resend; a packet resend unit which resends the packet in accordance with the request for a resend detected by the resend request detection unit; and a channel allocation unit which allocates a different communication channel for the packet resend unit to resend the packet from the communication channel which was used for sending the packet in which the error detected by the resend request unit was contained.

The second aspect of the present invention is the wireless communication system according to the first aspect in which the communication channel may be a subchannel used in an OFDMA system which handles the frequency bands used for communication in subchannel units which are made up of a plurality of subcarriers.

The third aspect of the present invention is the wireless communication system according to the second aspect in which the channel allocation unit may newly allocate the same number of subchannels for the packet resend unit to resend the packet as the number of subchannels which were used for sending the packet in which the error detected by the resend request unit was contained.

The fourth aspect of the present invention is the wireless communication system according to the third aspect in which the channel allocation unit may newly allocate the same number of subchannels for the packet resend unit to resend the packet as the number of subchannels which were used for sending the packet in which the error detected by the resend request unit was contained, and may allocate at least one subchannel which is different from the subchannels which were used for sending the packet in which the error detected by the resend request unit was contained.

The fifth aspect of the present invention is a wireless communication system which performs packet communication in a time division multiplexing communication format between wireless communication devices using a multicarrier communication system in which frequency bandwidths are adaptively allocated, and includes: a resend request unit which detects that a received packet contains an error and requests a resend; a resend request detection unit which detects the request for a resend; a packet resend unit which resends the packet in accordance with the request for a resend detected by the resend request detection unit; and a bandwidth allocation unit which allocates the same frequency bandwidth for the packet resend unit to resend the packet as the frequency bandwidth which was used for sending the packet in which the error detected by the resend request unit was contained.

The sixth aspect of the present invention is a base station device which performs packet communication in a time division multiplexing communication format with a wireless communication terminal using either one or a plurality of communication channels, and includes: a resend request detection unit which detects a resend request requested by the wireless communication terminal; a packet resend unit which resends the packet in accordance with the request for a resend detected by the resend request detection unit; and a channel allocation unit which allocates a different communication channel for the packet resend unit to resend the packet from the communication channel which was used previously for sending the same packet as the packet to be resent.

The seventh aspect of the present invention is the base station device according to the sixth aspect in which the communication channel may be a subchannel used in an OFDMA system which handles the frequency bands used for communication in subchannel units which are made up of a plurality of subcarriers.

The eighth aspect of the present invention is the base station device according to the seventh aspect in which the channel allocation unit may newly allocate the same number of subchannels for the packet resend unit to resend the packet as the number of subchannels which were used previously for sending the same packet as the packet to be resent.

The ninth aspect of the present invention is the base station device according to the eighth aspect in which the channel allocation unit may newly allocate the same number of subchannels for the packet resend unit to resend the packet as the number of subchannels which were used previously for sending the same packet as the packet to be resent, and may allocate at least one subchannel which is different from the subchannels which were used previously for sending the same packet as the packet to be resent.

The tenth aspect of the present invention is a wireless communication method in which packet communication is performed in a time division multiplexing communication format between wireless communication devices using either one or a plurality of communication channels, and includes: a resend request step in which it is detected that a received packet contains an error and a resend is requested; a resend request detection step in which the request for a resend is detected; a packet resend step in which the packet is resent in accordance with the request for a resend detected in the resend request detection step; and a channel allocation step in which, when the packet resend unit is resending the packet, a different communication channel is allocated from the communication channel which was used for sending the packet in which the error detected in the resend request step was contained.

The eleventh aspect of the present invention is a wireless communication system which includes first and second wireless communication devices which perform packet communication, and includes: a first error detection unit which, after performing error correction processing on a received packet received by the first wireless communication device, detects whether or not an error is present in the received packet on which the error correction processing was performed; a second error detection unit which, after the processing of the first error detection unit, performs a further error detection for the received packet on which the error correction processing was performed; a resend request unit which, in accordance with the result of the second error detection, requests the second wireless communication device to resend the same packet as the received packet; and a resend unit which, based on this request, resends the same packet as the received packet from the second wireless communication device.

The twelfth aspect of the present invention is the wireless communication system according to the eleventh aspect in which the wireless communication system may be further provided with a scheduling unit which determines the sending sequence of a transmission packet when this transmission packet is to be resent using the resend unit.

The thirteenth aspect of the present invention is the wireless communication system according to the twelfth aspect in which the packet communication may be conducted in ODFMA format between the first and second wireless communication devices, and there may be further provided a channel allocation unit which, when the same packet as the received packet is to be resent using the resend unit, allocates a different communication channel from the communication channel which was used for sending the same packet as the received packet prior to the resending.

The fourteenth aspect of the present invention is the wireless communication system according, to the eleventh aspect in which the packet communication may be conducted in ODFMA format between the first and second wireless communication devices, and there may be further provided a modulation format determination unit which, when the same packet as the received packet is to be resent using the resend unit, selects a different modulation format from the modulation format which was used to send the packet prior to the resending.

The fifteenth aspect of the present invention is the wireless communication system according to the fourteenth aspect in which, when the same packet as the received packet is to be resent using the resend unit, the modulation format determination unit may select a modulation format having a lower transmission rate than that of the modulation format which was used to send the packet prior to the resending.

The sixteenth aspect of the present invention is a wireless communication terminal which performs packet communication, and includes: a first error detection unit which, after performing error correction processing on a received packet, detects whether or not an error is present in the received packet on which the error correction processing was performed; a second error detection unit which, after the processing of the first error detection unit, performs a further error detection for the received packet on which the error correction processing was performed; and a resend request unit which, in accordance with the detection result from the second error detection unit, requests the base station to resend the same packet as the received packet.

The seventeenth aspect of the present invention is a base station comprising a resend unit which resends the same packet as the received packet in response to the resend request from the wireless communication terminal described in the sixteenth aspect.

The eighteenth aspect of the present invention is the base station device according to the seventeenth aspect in which there may be further provided a scheduling unit which determines the sending sequence of a transmission packet when this transmission packet is to be resent using the resend unit.

The nineteenth aspect of the present invention is the base station device according to the seventeenth aspect in which the packet communication may be conducted in ODFMA format between this host base station and the wireless communication terminal, and the base station may be further provided with a channel allocation unit which, when the same packet as the received packet is to be resent using the resend unit, allocates a different communication channel from the communication channel which was used for sending the same packet as the received packet prior to the resending.

The twentieth aspect of the present invention is the base station device according to the seventeenth aspect in which the packet communication may be conducted in ODFMA format between this host base station and the wireless communication terminal, and the base station may be further provided with a modulation format determination unit which, when the same packet as the received packet is to be resent using the resend unit, selects a different modulation format from the modulation format which was used to send the packet prior to the reseeding.

The twenty-first aspect of the present invention is the base station device according to the twentieth aspect in which when the same packet as the received packet is to be resent using the resend unit, the modulation format determination unit may select a modulation format having a lower transmission rate than that of the modulation format which was used to send the packet prior to the resending.

The twenty-second aspect of the present invention is a wireless communication method in which packet communication is performed between first and second wireless communication devices, and includes: a first step in which, error correction processing is performed on a received packet received by the first wireless communication device, and a detection is made as to whether or not an error is present in the received packet on which the error correction processing was performed; a second step in which, after the first step, a further error detection is made for the received packet on which the error correction processing was performed; a third step in which, in accordance with the result of the error detection of the second step, a request is made to the second wireless communication device to resend the same packet as the received packet; and a fourth step in which, based on this request, the same packet as the received packet is resent from the second wireless communication device.

The twenty-third aspect of the present invention is a wireless communication system which includes first and second wireless communication devices which perform packet communication, and includes: a first error detection unit which, after performing error correction processing on a received packet received by the first wireless communication device, detects whether or not an error is present in the received packet on which the error correction processing was performed; a second error detection unit which, after the processing of the first error detection unit, performs a further error detection for the received packet on which the error correction processing was performed; a resend request unit which, in accordance with the result of the second error detection, requests the second wireless communication device to resend the same packet as the received packet; a channel allocation unit which allocates a different communication channel from the communication channel which was used to send the packet which the resend request unit requested be resent; and a resend unit which, based on this resend request, resends the same packet as the received packet from the second wireless communication device using the communication channel allocated by the channel allocation unit.

According to the present invention, the frequency band which is used in the resending of a packet is allocated such that the frequency bandwidth which is used in the resending of a packet is identical to the frequency bandwidth used when the previous packet was sent. Because of this, according to the present invention, an H-ARQ can be made to function normally even when a frequency band is shared by a plurality of wireless communication terminals.

Moreover, according to the present invention, it is possible to prevent the occurrence of packet errors or of unnecessary resending in packet communication between a base station and a wireless communication terminal. Because of this, according to the present invention, it is possible to perform resending control in which there is no reduction in throughput.

### BRIEF DESCRIPTION OF THE DRAWINGS

FIG. 1 is a schematic structural view of a wireless communication system according to an embodiment of the present invention.

FIG. 2 is a typical view showing a relationship between slots and subchannels in the wireless communication system according to an embodiment of the present invention.

FIG. 3A is a structural block diagram of a base station according to an embodiment of the present invention.

FIG. 3B is a structural block diagram of a base station and a wireless communication terminal according to an embodiment of the present invention.

FIG. 4 is a structural block diagram of a modulation section according to an embodiment of the present invention.

FIG. 5A is an operation flowchart for a base station according to an embodiment of the present invention.

FIG. 5B is a sequence charts for a wireless communication system according to an embodiment of the present invention.

### REFERENCE SYMBOLS

CS Base station
PS Wireless communication terminal
1 QoS control section
2 Scheduler
3 Communication management section
4 Bandwidth allocation section
5, 31 MAC-PDU construction section
6, 32 PHY-PDU construction section
7, 33 Error correction encoding section
8, 34 Modulation section
9, 35 Transmission section
10, 20 Reception section
11, 21 Demodulation section
12, 23 Error correction decoding section
13, 27 PHY-PDU analysis section
13a H-ARQ response determination section
13b MAC-PDU response determination section
14 Resend control section
14a H-ARQ control section
14b MAC-ARQ control section
15, 28 Data reconstruction section
22 Maximum ratio synthesis section
24 Reception buffer
25 CRC detection section
26 H-ARQ resend request section
27a Resend format alteration detection section
29 Data sequence determination section
30 MAC-ARQ resend request section

### BEST MODE FOR CARRYING OUT THE INVENTION

Preferred embodiments of the present invention will now be described with reference made to the drawings. It should be noted, however, that the present invention is not limited to the respective embodiments described below and, for example, the various component elements of the embodiments may be combined in various appropriate combinations.

### First Embodiment

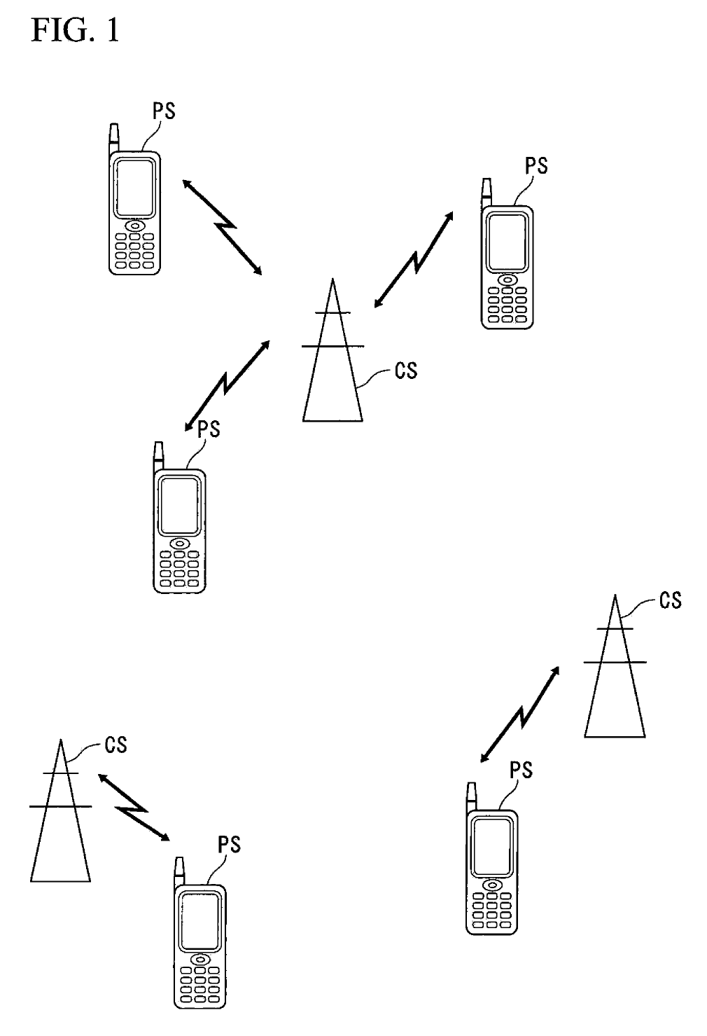

A first embodiment will now be described in detail with reference made to the drawings. As is shown in FIG. 1, the wireless communication system of the present embodiment is formed by a base station CS and wireless communication terminals PS and also by a network (not shown). The base station CS and wireless communication terminals PS perform communication using orthogonal frequency division multiple access (OFDMA) in addition to time division multiple access (TDMA) and time division duplex (TDD) for the multiple access connection technology. A plurality of base stations CS are provided at fixed distance intervals, and these perform wireless communication while providing multiple access between the plurality of wireless communication terminals PS. A case is described below in which the base stations CS are taken as the transmitting side, while the wireless communication terminals PS are taken as the receiving side.

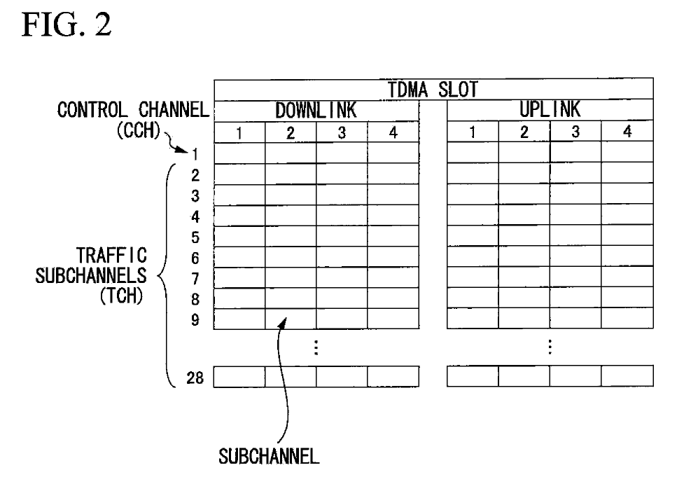

As is commonly known, OFDMA is a technology in which all subcarriers in an orthogonal relationship are shared by all the wireless communication terminals PS, and a grouping of an optional plurality of subcarriers is positioned as one group. By adaptively allocating either one or a plurality of groups to each wireless communication terminal PS, multiple access is achieved. In the wireless communication system of the present embodiment, time division multiple access (TDMA) and time division duplex (TDD) technologies are further combined with the above described OFDMA technology. Namely, each group is subjected to TDD by being divided between an uplink and a downlink in a time axial direction, and these uplinks and downlinks are then divided respectively into four TDMA slots. In addition, in the present embodiment, each unit obtained by dividing the respective groups into the respective TDMA slots in the time axial direction is referred to as a subchannel. FIG. 2 shows subchannel relationships between frequencies and TDMA slots in the wireless communication system of the present embodiment. The vertical axis shows frequency while the horizontal axis shows time. As is shown in FIG. 2, 112 subchannels made up of 28 channels in the frequency direction multiplied by 4 (i.e., 4 slots) channels in the time axial direction are allocated respectively for uplinks and downlinks.

In the wireless communication system of the present embodiment, as is shown in FIG. 2, the subchannel at the first end in the frequency direction from among all of the subchannels (i.e., number 1 in FIG. 2) is used as a control channel (CCH). Moreover, in the wireless communication system of the present embodiment, the remaining subchannels are used as traffic subchannels (TCH). In addition, any one or plurality of traffic subchannels from among the total number of subchannels belonging to both the uplink and downlink (in this case, 108 subchannels obtained by multiplying 27 by 4 slots with the CCH excluded) is allocated to the base station CS and wireless communication terminal PS which are carrying out the wireless communication. Note that the same traffic subchannels are allocated for the traffic subchannels of the uplink and downlink serving as communication channels.

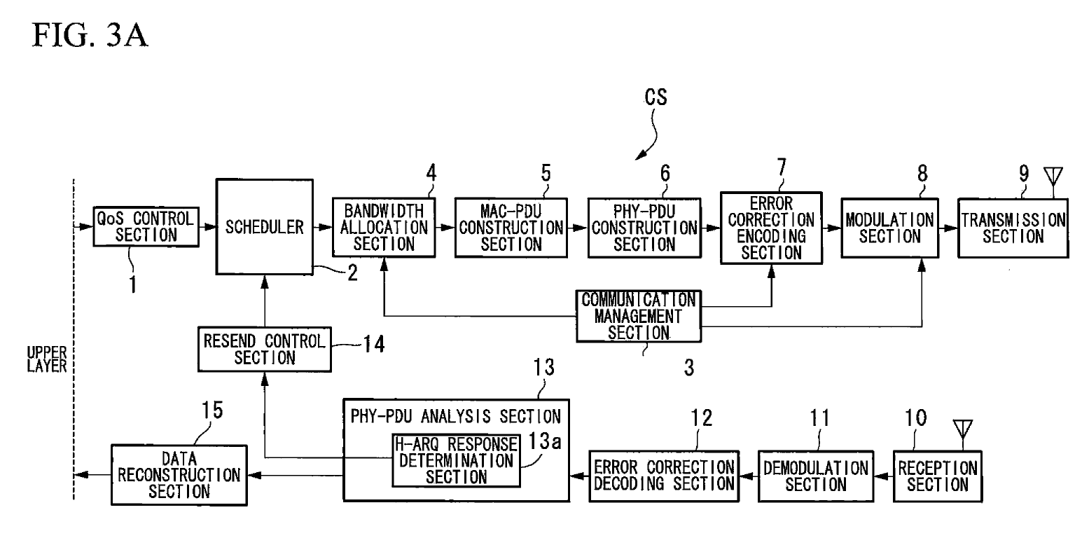

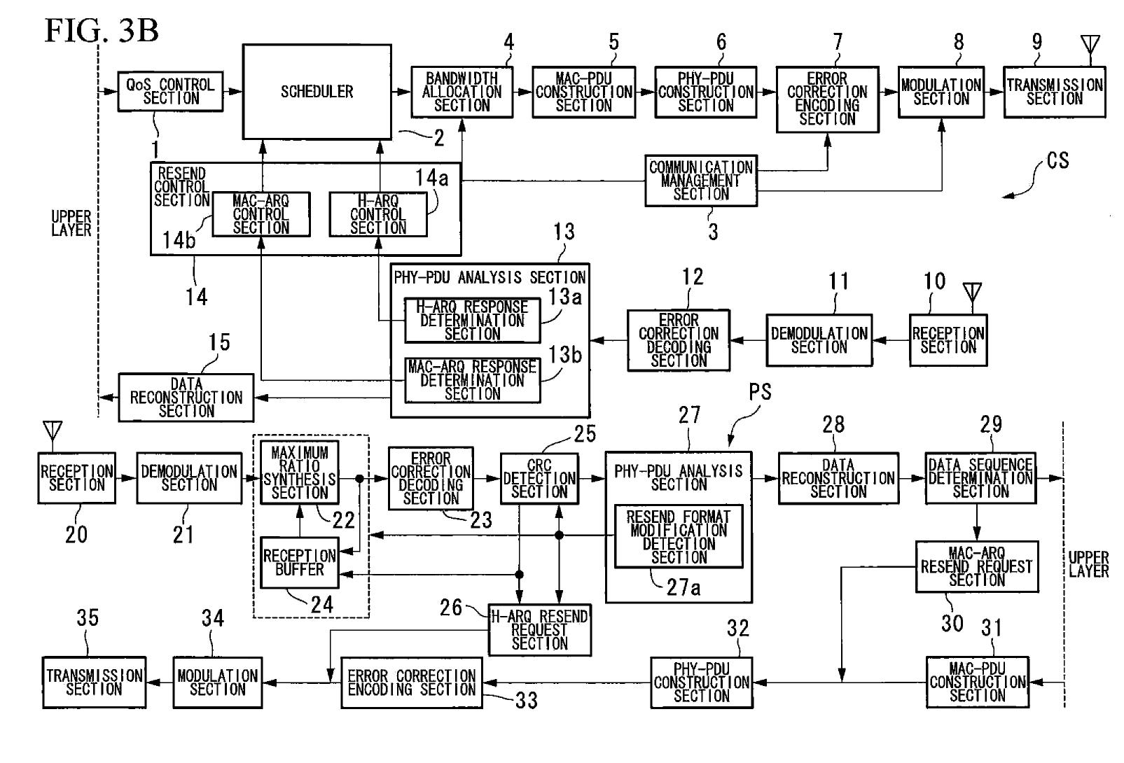

FIG. 3A is a block diagram showing the principal structure of a base station CS in the present embodiment. As is shown in FIG. 3A, the base station CS is provided with a QoS (Quality of Service) control section 1, a scheduler 2, a communication management section 3, a bandwidth allocation section 4, a MAC-PDU (Media Access Control—Protocol Data Unit) construction section 5, a PHY-PDU (PHYsical-Protocol Data Unit) construction section 6, an error correction encoding section 7, a modulation section 8, a transmitting section 9, a receiving section 10, a demodulation section 11, an error correction decoding section 12, a PHY-PDU analysis section 13, a resend control section 14, and a data reconstruction section 15. In addition, the PHY-PDU analysis section 13 is provided with an H-ARQ response determination section 13a.

Note that in the base station CS, the QoS (Quality of Service) control section 1, the scheduler 2, the communication management section 3, the bandwidth allocation section 4, the MAC-PDU construction section 5, the PHY-PDU construction section 6, the PHY-PDU analysis section 13, the resend control section 14, and the data reconstruction section 15 are functional component elements relating to the MAC (Media Access Control) layer. Moreover, the error correction encoding section 7, the modulation section 8, the transmitting section 9, the receiving section 10, the demodulation section 11, and the error correction decoding section 12 are functional component elements relating to the physical layer. Note that in FIG. 3A, functional component elements relating to layers above the MAC layer have been omitted.

The QoS control section 1 allocates priority to data (i.e., payload) input from an upper layer based on the applications which are operating on the higher layers and on the user priorities of the wireless communication terminals PS which are connected for communication, and controls the scheduler 2 such that transmitting and receiving timings for packets (namely, MAC-PDU) formed by this data are allocated.

The scheduler 2 controls the flow of MAC-PDU input from the QoS control section 1. Moreover, under the control of the QoS control section 1, the scheduler 2 also determines the transmission sequence of packets needing to be transmitted based on the service class which has been allocated to each wireless communication terminal PS which is connected for communication, and on the state of the wait queue of packets (MAC-PDU) between the base station CS and the wireless communication terminals PS. Furthermore, based on commands from the resend control section 14, the scheduler 2 also determines the transmission sequence of resend packets. The communication management section 3 allocates packet encoding rates and modulation formats in accordance with the quality of communication between the wireless communication terminals PS which are connected for communication.

The bandwidth allocation section 4 determines the subchannel which is allocated to each packet based on information relating to the priority input from the QoS control section 1, on information relating to the transmission data amount and information relating to the communication permitted bandwidths input from the scheduler 2, and on information relating to the modulation format input from the communication management section 3. This subchannel allocation information is known as MHP information. Moreover, when a packet is to be resent, this bandwidth allocation section 4 also allocates a subchannel which is able to secure the same frequency bandwidth during the sending of the resend packet as that used during the previous sending of the packet. The MAC-PDU construction section 5 attaches MAC headers and CRC codes to packets input from the scheduler 2 via the bandwidth allocation section 4 so as to construct a MAC-PDU, and outputs this to the PHY-PDU construction section 6.

The PHY-PDU construction section 6 attaches a physical layer header which includes MAP information and control information such as the code rate and modulation format to a MAC-PDU which was output at a predetermined timing (i.e., in the downlink slot) from the scheduler 2, and constructs a downlink PHY-PDU, namely, a PHY-PDU to be transmitted to the wireless communication terminal PS. Next, the PHY-PDU construction section 6 outputs a bit string of this PHY-PDU to the error correction encoding section 7. The error correction encoding section 7 is, for example, an FEC (Forward Error Correction) encoder and, based on an encoding rate allocated by the control management section 3, attaches an error correction code, which is redundant information, to the bit string of the PHY-PDU, and outputs it to the modulation section 8.

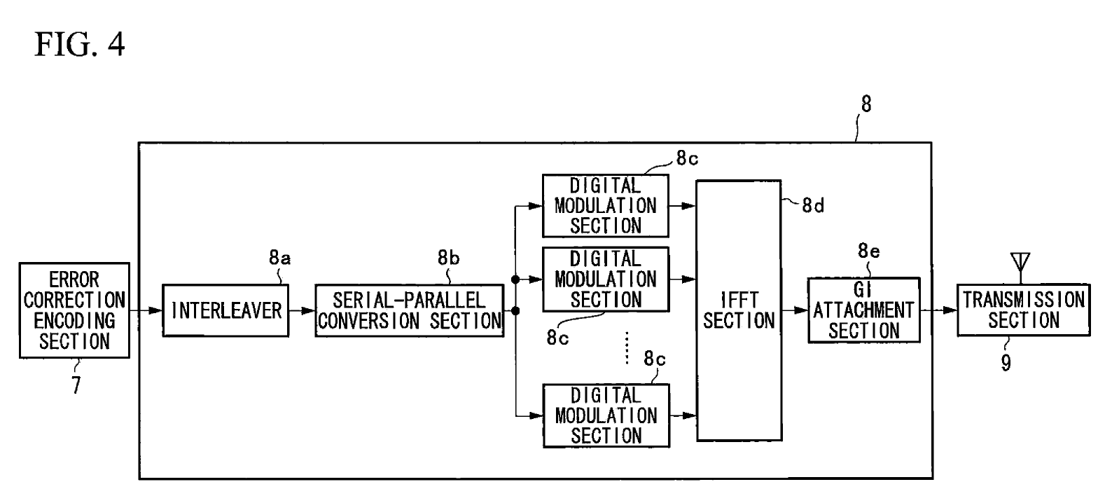

FIG. 4 is a schematic structural view of the modulation section 8. As is shown in FIG. 4, the modulation section 8 is provided with an interleaver 8a, a serial-parallel conversion section 8b, a digital modulation section 8c, an IFFT (Inverse Fast Fourier Transform) section 8d, and a GI (Guard Interval) attachment section 8e.

The interleaver 8a performs interleaving processing on bit strings of the PHY-PDU to which error correction code has been attached by the error correction encoding section 7. The serial-parallel conversion section 8b divides the bit strings of the PHY-PDU which have undergone interleaving processing into bit units for each subcarrier contained in the subchannel allocated by the bandwidth allocation section 4, and outputs them to the digital modulation section 8c. The same number of digital modulation sections 8c are provided as the number of subcarriers, and, using the subcarrier which corresponds to the relevant piece of bit data, they perform digital modulation on the bit data which has been divided between the respective subcarriers, and outputs a modulation signal to the IFFT section 8d. Note that each digital modulation section 8c performs digital modulation using a modulation format allocated by the communication management section 3 such as, for example, BPSK (Binary Phase Shift Keying), QPSK (Quadrature Phase Shift Keying), 16 QAM (Quadrature Amplitude Modulation), and 64 QAM, and the like.

The IFFT section 8d performs an inverse Fourier transform on modulation signals input from each digital modulation section 8c and performs orthogonal multiplexing thereon so as to create OFDM signals. These OFDM signals are then output to the GI attachment section 8e. The GI attachment section 8e attaches a guard interval (GI) to the OFDM signal input from the IFFT section 8d and outputs it to the transmission section 9.

The description will now return to FIG. 3A. The transmission section 9 converts the OFDM signal input from the GI attachment section 8e into an RF signal and transmits it to a wireless communication terminal PS. The reception section 10 receives RF signals transmitted from the wireless communication terminals PS, and performs frequency conversion on the RF signals so as to convert them into OFDM signals and then outputs them to the demodulation section 11.

The demodulation section 11 performs demodulation on OFDM signals (namely, reception signals) input from the reception section 10. Specifically, this demodulation section 11 performs demodulation on reception signals by performing the reverse processing from that performed by the modulation section 8. Namely, the demodulation section 11 firstly removes the guard interval from reception signals, and then divides the reception signals into modulation signals for each subcarrier by performing FFT processing. It then performs digital demodulation on each modulation signal. Furthermore, the demodulation section 11 performs parallel-serial conversion on the bit data obtained by demodulation, and then performs de-interleaving processing thereon so as to reconstruct the bit string. Note that these reconstructed bit strings are the same as the bit strings showing the PHY-PDU which were received from the wireless communication terminal PS.

The error correction decoding section 12 is, for example, an FEC decoder. The error correction decoding section 12 performs error correction decoding on received PHY-PDU bit strings which are input from the demodulation section 11, and outputs the error-corrected bit strings to the PHY-PDU analysis section 13. The PHY-PDU analysis section 13 analyzes the received PHY-PDU bit strings, and extracts various types of control information contained in the physical layer header and MAC header and also extracts a payload which is data information. The PHY-PDU also extracts the MAC-PDU and outputs it to the data reconstruction section 15. The H-ARQ response determination section 13a in the PHY-PDU analysis section 13 determines whether or not a received. PHY-PDU is an ACK signal or a NACK signal relating to H-ARQ from the result of the analysis of the received PHY-PDU, and outputs a determination result to the resend control section 14.

When it is determined that the received PHY-PDU is a NACK signal relating to H-ARQ based on determination results from the H-ARQ response determination section 13a, the resend control section 14 controls the scheduler 2 such that the packet (MAC-PDU) for which a resend request was made from a wireless communication terminal PS is resent in H-ARQ format. Moreover, when it is determined that the received PHY-PDU is an ACK signal relating to H-ARQ based on determination results from the H-ARQ response determination section 13a, the resend control section 14 controls the scheduler 2 such that the next packet (MAC-PDU) is sent to the wireless communication terminal PS.

After a sequence has been arranged for each group of the MAC-PDU input from the PHY-PDU analysis section 13, the data reconstruction section 15 removes the MAC header and CRC code from each MAC-PDU in the relevant group, and outputs upper layer data (i.e., payload) to the upper layer.

Note that the description in FIG. 3A relates to a base station CS, however, the wireless communication terminals PS are also provided with the component elements of the base station CS (and, accordingly, they are omitted from the drawing). However, the QoS control section 1, the scheduler 2, the communication management section 3, and the bandwidth allocation section 4 in the base station CS are component elements which are peculiar to the base station CS, and the wireless communication terminals PS are not provided with these component elements. Because of this, when a wireless communication terminal PS sends a packet resend request to the base station CS, the subchannel, modulation format, and encoding rate allocation to be used during the resending are notified to the wireless communication terminal PS.

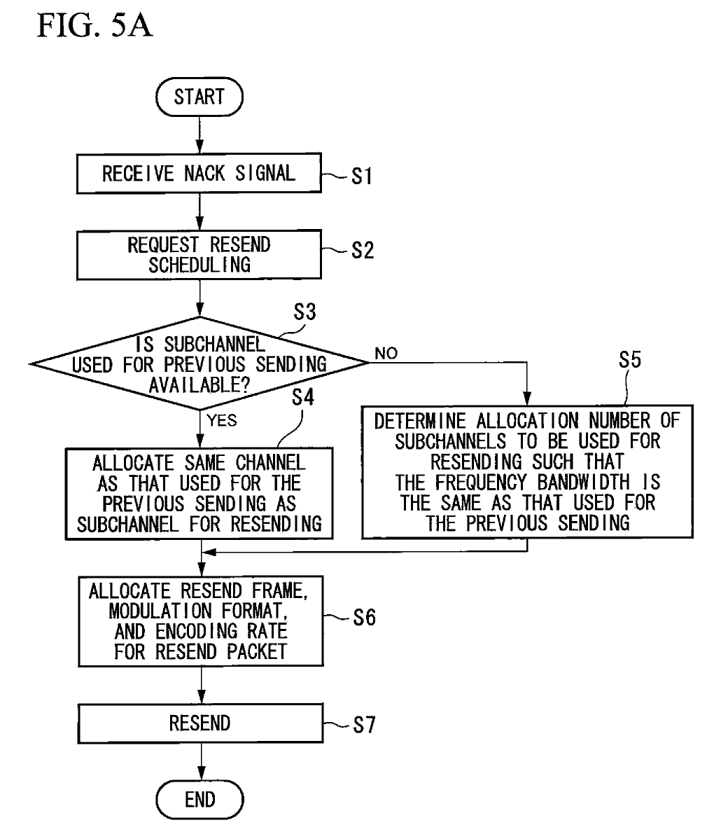

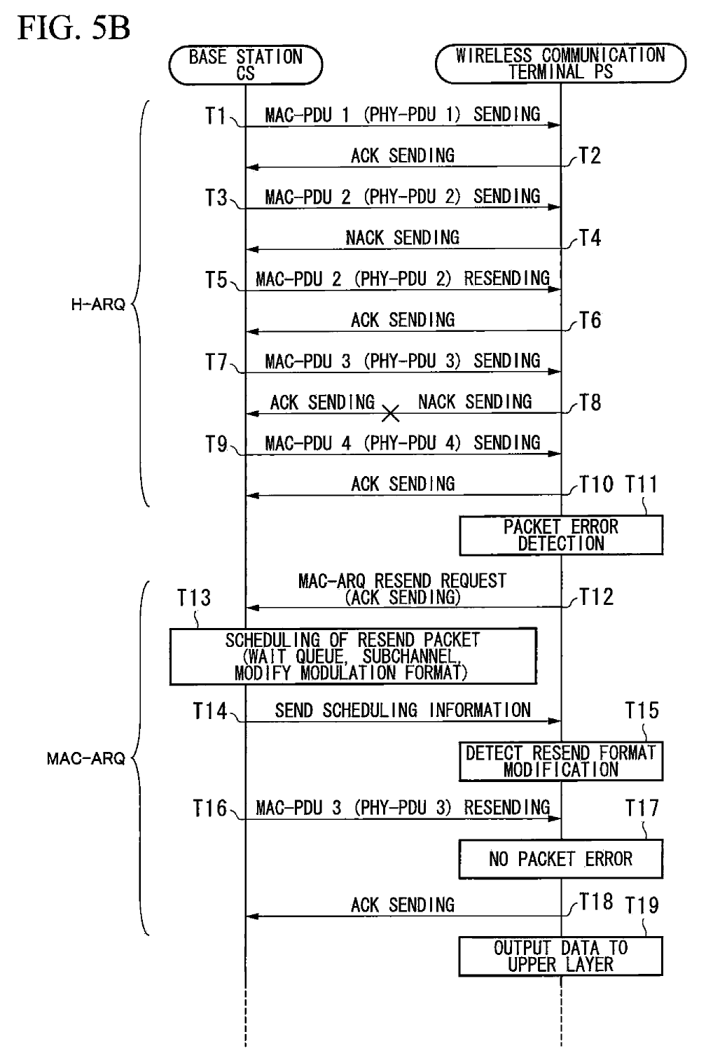

Next, a description of an operation during a resending of the CS which is structured in the manner described above will be given using the flowchart shown in FIG. 5A. Note that in the description given below, the base station CS is taken to be the transmitting side while the wireless communication terminals PS are taken to be the receiving side. Moreover, after performing error correction decoding processing on received packets received from the base station CS, the wireless communication terminals PS perform error correction on the received packets using the CRC code which is attached to the received packets. In the description given below, a case is assumed in which an error is detected by this processing in a received packet.

The wireless communication terminal PS performs error correction decoding of a received packet, and then detects errors in the received packet using the CRC code. If an error is detected in the received packet as a result of this processing, the wireless communication terminal PS stores the received packet in which the CRC error was detected in an internally provided reception buffer. Furthermore, the wireless communication terminal PS also sends a resend request signal (i.e., a NACK signal) to the base station CS via the ACK channel inside the control channel.

In the base station CS, the PHY-PDY analysis section 13 which receives the NACK signal relating to the aforementioned H-ARQ from the wireless communication terminal PS via the reception section 10 (step S1) receives this NACK signal via the demodulation section 11 and the error correction decoding section 12. In this PHY-PDU analysis section 13, the H-ARQ response determination section 13a determines that the received PHY-PDU is a NACK signal relating to H-ARQ as a result of the analysis of the received PHY-PDU which shows this NACK signal. The H-ARQ response determination section 13a outputs this determination result to the resend control section 14. Based on the determination result from the H-ARQ response determination section 13a, the resend control section 14 issues a request to the scheduler 12 to resend the packet for which the resend request was made from the wireless communication terminal PS (step S2).

When the packet for which the resend request was made is being resent, the bandwidth allocation section 4 determines whether or not the subchannel which was used for the previous sending is available (step S3). Specifically, based on the MAP information shown in FIG. 2, the bandwidth allocation section 4 determines whether or not the subchannel which was used for the previous sending has been allocated to another wireless communication terminal PS.

In step S3, if the subchannel which was used for the previous sending is available (i.e., [Yes]), then the bandwidth allocation section 4 allocates the same channel that was used for the previous sending as the subchannel for sending the resend packet (step S4).

If, however, in step S3, not even one subchannel which was used for the previous sending is available (i.e., [No]), the bandwidth allocation section 4 decides an allocation number for the subchannel for sending the resend packet such that the same frequency bandwidth as the frequency bandwidth which was used during the previous sending of the packet can be secured (step S5). Namely, if there were a plurality of subchannels which for the previous sending of the packet (namely, for the sending of the packet in which an error was detected), then the bandwidth allocation section 4 newly allocates the same number of subchannels as the number of subchannels which were previously used. At this time, provided that it is possible to secure the same frequency bandwidth as the frequency bandwidth used for the previous packet sending, then it is possible for subchannels which are different from the subchannels used for the previous packet sending to be included therein.

Next, the communication management section 3 allocates a modulation format and encoding rate (the modulation format and encoding rate are the same as those that were used for the previous sending). The scheduler 2 decides the resend timing (i.e., resend frame) to be used during the resending (step S6). In addition, the base station CS sends the resend packet to the wireless communication terminal PS via the PHY-PDU construction section 6, the error correction encoding section 7, the modulation section 8, and the transmission section 9 at a predetermined resend timing (step S7).

As is described above, in the present embodiment, during an H-ARQ resending, if it is not possible to allocate the same subchannel as was used for the previous sending, then a number of subchannels to be allocated for sending the resend packet are established so as to enable the same frequency bandwidth as the frequency bandwidth which was used for the previous sending to be secured. Namely, because it is possible to secure the same frequency bandwidth for resending the H-ARQ as the frequency bandwidth which was used for the previous sending, the H-ARQ can be allowed to function normally.

Note that in the above described embodiment, an example is described of a base station CS in a wireless communication system which employs orthogonal frequency division multiple access (OFDMA) in addition to time division multiple access (TDMA) and time division duplex (TDD). However, the present invention is not limited to this. For example, the above described embodiment can also be applied to base stations in wireless communication systems which perform packet communication in a time division multiplex communication format using either one or a plurality of communication channels between wireless communication devices. Moreover, for example, the above described embodiment can also be applied to base stations in wireless communication systems which perform packet communication in a time division multiplex communication format using a multi-carrier communication format in which frequency bands are adaptively allocated between wireless communication devices.

### Second Embodiment

A wireless communication system, base station, wireless communication terminal, and wireless communication method according to a second embodiment will now be described in detail with reference made to the drawings.

Note that, in the present embodiment, the same drawings and symbols are used for component elements which are the same as those in the above described first embodiment. Moreover, in the present embodiment, FIG. 1 and FIG. 2 apply in the same way as in the above described first embodiment.

FIG. 3B is a block diagram showing the principal structure of a base station CS and a wireless communication terminal PS in the present embodiment. As is shown in FIG. 3B, the base station CS is provided with a QoS (Quality of Service) control section 1, a scheduler 2, a communication management section 3, a bandwidth allocation section 4, a MAC-PDU (Media Access Control—Protocol Data Unit) construction section 5, a PHY-PDU (PHYsical-Protocol Data Unit) construction section 6, an error correction encoding section 7, a modulation section 8, a transmitting section 9, a receiving section 10, a demodulation section 11, an error correction decoding section 12, a PHY-PDU analysis section 13, a resend control section 14, and a data reconstruction section 15. In addition, the PHY-PDU analysis section 13 is provided with an H-ARQ response determination section 13a. Furthermore, the resend control section 14 is provided with an H-ARQ control section 14a and a MAC-ARQ control section 14b.

Note that in the base station CS, the QoS (Quality of Service) control section 1, the scheduler 2, the communication management section 3, the bandwidth allocation section 4, the MAC-PDU construction section 5, the PHY-PDU construction section 6, the PHY-PDU analysis section 13, the resend control section 14, and the data reconstruction section 15 are functional component elements relating to the MAC (Media Access Control) layer. Moreover, the error correction encoding section 7, the modulation section 8, the transmitting section 9, the receiving section 10, the demodulation section 11, and the error correction decoding section 12 are functional component elements relating to the physical layer. Note that in FIG. 3B, functional component elements relating to layers above the MAC layer have been omitted.

The QoS control section 1 allocates priority to data (i.e., payload) input from an upper layer based on the applications which are operating on the higher layers and on the user priorities of the wireless communication terminals PS which are connected for communication. In addition, the QoS control section 1 controls the scheduler 2 such that transmitting and receiving timings for packets (namely, MAC-PDU) formed by this data are allocated.

The scheduler 2 controls the flow of MAC-PDU input from the QoS control section 1. Moreover, under the control of the QoS control section 1, the scheduler 2 also determines the transmission sequence of packets needing to be transmitted based on the service class which has been allocated to each wireless communication terminal PS which is connected for communication, and on the state of the wait queue of packets (MAC-PDU) between the base station CS and the wireless communication terminals PS. Furthermore, based on commands from the resend control section 14, the scheduler 2 also determines the transmission sequence of resend packets. The communication management section 3 allocates packet encoding rates and modulation formats in accordance with the quality of communication between the wireless communication terminals PS which are connected for communication.

The bandwidth allocation section 4 determines the subchannel which is allocated to each packet based on information relating to the priority input from the QoS control section 1, on information relating to the transmission data amount and information relating to the communication permitted bandwidths input from the scheduler 2, and on information relating to the modulation format input from the communication management section 3. This subchannel allocation information is known as MHP information. The MAC-PDU construction section 5 attaches MAC headers and CRC codes to packets input from the scheduler 2 via the bandwidth allocation section 4 so as to construct a MAC-PDU, and outputs this to the PHY-PDU construction section 6.

The PHY-PDU construction section 6 attaches a physical layer header which includes MAP information and control information such as the code rate and modulation format to a MAC-PDU which was output at a predetermined timing (i.e., in the downlink slot) from the scheduler 2, and constructs a downlink PHY-PDU, namely, a PHY-PDU to be transmitted to the wireless communication terminal PS. Moreover, the PHY-PDU construction section 6 outputs a bit string of this PHY-PDU to the error correction encoding section 7. The error correction encoding section 7 is, for example, an FEC (Forward Error Correction) encoder. Based on an encoding rate allocated by the control management section 3, the PHY-PDU construction section 6 attaches an error correction code, which is redundant information, to the bit string of the PHY-PDU, and outputs it to the modulation section 8.

FIG. 4 is a schematic structural view of the modulation section 8. As is shown in FIG. 4, the modulation section 8 is provided with an interleaver 8a, a serial-parallel conversion section 8b, a digital modulation section 8c, an IFFT (Inverse Fast Fourier Transform) section 8d, and a GI (Guard Interval) attachment section 8e.

The interleaver 8a performs interleaving processing on bit strings of the PHY-PDU to which error correction code has been attached by the error correction encoding section 7. The serial-parallel conversion section 8b divides the bit strings of the PHY-PDU which have undergone interleaving processing into bit units for each subcarrier contained in the subchannel allocated by the bandwidth allocation section 4, and outputs them to the digital modulation section 8c. The same number of digital modulation sections 8c are provided as the number of subcarriers. Using the subcarrier which corresponds to the relevant piece of bit data, the digital modulation sections 8c perform digital modulation on the bit data which has been divided between the respective subcarriers, and outputs a modulation signal to the IFFT section 8d. Note that each digital modulation section 8c performs digital modulation using a modulation format allocated by the communication management section 3 such as for example, BPSK (Binary Phase Shift Keying), QPSK (Quadrature Phase Shift Keying), 16 QAM (Quadrature Amplitude Modulation), and 64 QAM, and the like.

The IFFT section 8d performs an inverse Fourier transform on modulation signals input from each digital modulation section 8c and performs orthogonal multiplexing thereon so as to create OFDM signals. The IFFT section 8d then outputs these OFDM signals to the GI attachment section 8e. The GI attachment section 8e attaches a guard interval (GI) to the OFDM signal input from the IFFT section 8d and outputs it to the transmission section 9.

The description will now return to FIG. 3B. The transmission section 9 converts the OFDM signal input from the GI attachment section 8e into an RF signal and transmits it to a wireless communication terminal PS. The reception section 10 receives RF signals transmitted from the wireless communication terminals PS, and performs frequency conversion on the RF signals so as to convert them into OFDM signals and then outputs them to the demodulation section 11.

The demodulation section 11 performs demodulation on OFDM signals (namely, reception signals) input from the reception section 10. Specifically, this demodulation section 11 performs demodulation on reception signals by performing the reverse processing from that performed by the modulation section 8. Namely, the demodulation section 11 firstly removes the guard interval from reception signals, and then divides the reception signals into modulation signals for each subcarrier by performing FFT processing. The demodulation section 11 then performs digital demodulation on each modulation signal. Furthermore, the demodulation section 11 performs parallel-serial conversion on the bit data obtained by this demodulation, and then performs de-interleaving processing thereon so as to reconstruct the bit string. Note that these reconstructed bit strings are the same as the bit strings showing the PHY-PDU which were received from the wireless communication terminal PS.

The error correction decoding section 12 is, for example, an FEC decoder. The error correction decoding section 12 performs error correction decoding on received PHY-PDU bit strings which are input from the demodulation section 11, and outputs the error-corrected bit strings to the PHY-PDU analysis section 13. The PHY-PDU analysis section 13 analyzes the received PHY-PDU bit strings, and extracts various types of control information contained in the physical layer header and MAC header and also extracts a payload which is data information. The PHY-PDU also extracts the MAC-PDU and outputs it to the data reconstruction section 15. Here, a description is given, in particular, of the H-ARQ response determination section 13a and the MAC-ARQ response determination section 13b from among the functional elements of the PHY-PDU analysis section 13 in the present embodiment.

The H-ARQ response determination section 13a determines whether or not the received PHY-PDU is an ACK signal or a NACK signal relating to H-ARQ from the result of the analysis of the reception PHY-PDU, and outputs a determination result to the H-ARQ control section 14a of the resend control section 14. In addition, the MAC-ARQ response determination section 13b determines whether or not the received PHY-PDU is an ACK signal or a NACK signal relating to MAC-ARQ from the result of the analysis of the reception PHY-PDU, and outputs a determination result to the MAC-ARQ control section 14b of the resend control section 14.

If it is determined that the received PHY-PDU is a NACK signal relating to H-ARQ based on determination results from the H-ARQ response determination section 13a, the resend control section 14a controls the scheduler 2 such that the packet (MAC-PDU) for which a resend request was made from a wireless communication terminal PS is resent in H-ARQ format. Moreover, if it is determined that the received PHY-PDU is an ACK signal relating to the H-ARQ based on determination results from the H-ARQ response determination section 13a, the resend control section 14a controls the scheduler 2 such that the next packet (MAC-PDU) is sent to the wireless communication terminal PS.

If it is determined that the received PHY-PDU is a NACK signal relating to MAC-ARQ based on determination results from the MAC-ARQ response determination section 13b, the resend control section 14b controls the scheduler 2 such that the packet (MAC-PDU) for which a resend request was made from a wireless communication terminal. PS is resent in MAC-ARQ format. Moreover, when it is determined that the received PHY-PDU is an ACK signal relating to MAC-ARQ based on determination results from the MAC-ARQ response determination section 13b, the resend control section 14b controls the scheduler 2 such that the next packet (MAC-PDU) is sent to the wireless communication terminal PS.

Here, the above described resending in H-ARQ format refers to a method in which a resend packet is sent using the same subchannel, modulation format, and encoding rate on the receiving side, namely, in the wireless communication terminal PS as those used when the packet in which a CRC error was detected was originally sent. The reason for this is that, in resend control based on H-ARQ, in order to perform maximum ratio synthesis on the receiving side between the packet in which a CRC error was detected and a resend packet, it is necessary for the resend packet to be sent using the same subchannel (namely, frequency band), modulation format, and encoding rate as those used for the previously sent packet. In contrast, the above described resending in MAC-ARQ format refers to a method in which the previously sent packet is resent, and when this previously sent packet is resent, it is possible for the subchannel and the modulation format to be modified compared to when the packet was previously sent.

After a sequence has been arranged for each group of the MAC-PDU input from the PHY-PDU analysis section 13, the data reconstruction section 15 removes the MAC header and CRC code from each MAC-PDU in the relevant group, and outputs upper layer data (i.e., payload) to the upper layer.

Next, a description will be given of the structure of a wireless communication terminal PS. As is shown in FIG. 1, a wireless communication terminal PS is provided with a reception section 20, a demodulation section 21, a maximum ratio synthesis section 22, an error correction decoding section 23, a reception buffer 24, a CRC detection section 25, a H-ARQ resend request section 26, a PHY-PDU analysis section 27, a data reconstruction section 28, a data sequence determination section 29, a MAC-ARQ resend request section 30, a MAC-PDU construction section 31, a PHY-PDU construction section 32, an error correction encoding section 33, a modulation section 34, and a transmission section 35. In addition, the PHY-PDU analysis section 27 is provided with a resend format modification detection section 27a.

The reception section 20 receives RF signals transmitted from the transmission section 7 of the base station CS, and performs frequency conversion on the RF signals so as to convert them into OFDM signals and then outputs them to the demodulation section 21. The demodulation section 21 has the same type of component elements as the demodulation section 11 of the base station CS and, therefore, a description thereof is omitted here.

The maximum ratio synthesis section 22 performs maximum ratio synthesis on bit strings which show a received PHY-PDU (i.e., a resend PHY-PDU) input from the demodulation section 21 and bit strings of a received PHY-PDU in which a CRC error was detected previously and which was then stored in the reception buffer 24. The maximum ratio synthesis section 22 outputs a maximum ratio-synthesized bit string to the error correction decoding section 23 and the reception buffer 24. Note that if a PHY-PDU other than a resend PHY-PDU is received, the maximum ratio synthesis section 22 outputs this received PHY-PDU to the error correction decoding section 23 and reception buffer 24 without performing maximum ratio synthesis thereon.

The error correction decoding section 23 has the same type of component elements as the error correction decoding section 12 of the base station CS and, therefore, a description thereof is omitted here. The reception buffer 24 stores received PHY-PDU (namely, PHY-PDU in which a CRC error has been detected) input from the maximum ratio synthesis section 22 in accordance with a request from the CRC detection section 25. Moreover, the reception buffer 24 also outputs stored received PHY-PDU to the maximum ratio synthesis section 22 in accordance with a request from the maximum ratio synthesis section 22. The CRC detection section 25 performs CRC error detection on received PHY-PDU which have undergone error correction decoding, in the error correction decoding section 23. When a CRC error is detected, the CRC detection section 25 makes a request for the reception buffer 24 to store the reception PHY-PDU, and notifies the H-ARQ resend request section 26 that a CRC error has been detected. This CRC detection section 25 also outputs the received PHY-PDU to the PHY-PDU analysis section 27.

When the H-ARQ resend request section 26 receives notification from the CRC detection section 25 that a CRC error has been detected in a reception PHY-PDU, it generates a PHY-PDU showing a NACK signal relating to H-ARQ. Furthermore, the H-ARQ resend request section 26 also sends the NACK signal to the base station CS via the modulation section 34 and transmission section 35 using an ACK channel within the control channel. If the H-ARQ resend request section 26 receives notification from the CRC detection section 25 that a CRC error has not been detected in a reception PHY-PDU, it generates a PHY-PDU showing an ACK signal relating to H-ARQ. The H-ARQ resend request section 26 also sends the ACK signal to the base station CS via the modulation section 34 and transmission section 35 using the ACK channel.

The PHY-PDU analysis section 27 is the same as the PHY-PDU analysis section 13 in the base station CS. However, here, a description will be given of the resend format modification detection section 27a which is the characteristic functional element of the receiving side if the resend format modification detection section 27a detects as a result of analyzing the received PHY-PDU that a resend control format has been modified from H-ARQ to MAC-ARQ, it issues a request for operations of the maximum ratio synthesis section 22, the reception buffer 24, the CRC detection section 25, and the H-ARC resend request section 26 to be halted. Note that this resend format modification detection section 27a detects whether or not the resend format has been modified by detecting if a modulation indicator (MI) from the control information included in the received PHY-PDU has changed during the resending.

Moreover, in the above described halted state, the maximum ratio synthesis section 22 and the CRC detection section 25 simply allow the received PHY-PDU to pass through, while operations of the reception buffer 24 and the H-ARQ resend request section 26 are temporarily interrupted. Namely, the characteristic operation of the H-ARQ is not performed.

The data reconstruction section 28 has the same type of component elements as the data reconstruction section 15 of the base station CS and, therefore, a description thereof is omitted here. The data sequence determination section 29 detects any errors in a packet by performing sequence determination for the MAC-PDU of one group received from the base station CS, and notifies the MAC-ARQ resend request section 30 about the result of this detection. When a packet error is detected based on this packet error detection result, the MAC-ARQ resend request section 30 generates a MAC-PDU showing a NACK signal relating to MAC-ARQ. The MAC-ARQ resend request section 30 sends the NACK signal to the base station CS via the PHY-PDU construction section 32, the error correction encoding section 33, the modulation section 34, and the transmission section 35 using an ACK channel. Moreover, when a packet error is not detected based on the packet error detection result, the MAC-ARQ resend request section 30 generates a MAC-PDU showing an ACK signal relating to MAC-ARQ. The MAC-ARQ resend request section 30 sends the ACK signal to the base station CS via the PHY-PDU construction section 32, the error correction encoding section 33, the modulation section 34, and the transmission section 35 using an ACK channel.

The MAC-PDU construction section 31, the PHY-PDU construction section 32, the error correction encoding section 33, the modulation section 34, and the transmission section 35 have the same type of component elements as the MAC-PDU construction section 5, the PHY-PDU construction section 6, the error correction encoding section 7, the modulation section 8, and the transmission section 9 of the base station CS and, therefore, a description thereof is omitted here.

Note that for reasons of convenience in the description of FIG. 3B, a case is assumed in which the base station CS is the transmitting side and the wireless communication terminals PS are the receiving side. However, because wireless communication is 2-directional, the base station CS is provided with the component elements of the wireless communication terminals PS and the wireless communication terminals PS are provided with the component elements of the base station CS. However, because the QoS control section 1, the scheduler 2, the communication management section 3, and the bandwidth allocation section 4 in the base station CS are component elements which are peculiar to the base station CS, the wireless communication terminals PS are not provided with these component elements. Because of this, when the transmitting side is a wireless communication terminal PS, notification is made from the base station CS to the wireless communication terminal PS concerning the subchannel, modulation format, and encoding rate allocation to be used during the reseeding.

Next, a description will be given of a communication operation between the base station CS and a wireless communication terminal PS in the wireless communication system constructed in the manner described above using the sequence chart shown in FIG. 5B. In the description given below as well, it is assumed that the base station CS is the transmitting side and the wireless communication terminal PS is the receiving side. In addition, a case is assumed in which four packets. MAC-PDU 1 (PHY-PDU 1)˜MAC-PDU 4 (PHY-PDU 4) from the base station CS form the data set of one group and are sent to the wireless communication terminal PS.

In FIG. 5B, firstly, using the subchannel, modulation format, and encoding rate which were scheduled in advance when the communication connection with the wireless communication terminal PS was established, the base station CS sends a PHY-PDU 1 to the wireless communication terminal PS via the transmitting section 9 (step T1). The wireless communication terminal PS receives this PHY-PDU 1 via the receiving section 20, and once the PHY-PDU 1 has been demodulated by the demodulation section 21, it is output to the maximum ratio synthesis section 22. At this time, because the PHY-PDU 1 is not a resend packet, it is input into the CRC detection section 25 via the error correction decoding section 23 without undergoing maximum ratio synthesis.

Here, a case is assumed in which a CRC error is not detected when the CRC detection section 25 performs CRC error detection on the PHY-PDU 1. The H-ARQ resend request section 26 generates a PHY-PDU indicating an ACK signal relating to H-ARQ. The H-ARQ resend request section 26 sends this ACK signal to the base station CS via the modulation section 34 and the resend section 35 using an ACK channel (step T2). Meanwhile, the data reconstruction section 28 receives the input of the PHY-PDU 1 via the PHY-PDU analysis section 27.

The base station CS receives the ACK signal relating to the H-ARQ via the receiving section 10 from the wireless communication terminal PS. The PHY-PDU analysis section 13 receives this ACK signal via the demodulation section 11 and the error correction decoding section 12. In this PHY-PDU analysis section 13, the H-ARQ response determination section 13a obtains analysis results of the received PHY-PDU indicating the above described ACK signal, and determines that the received PHY-PDU is an ACK signal relating to H-ARQ. The H-ARQ response determination section 13a outputs this determination result to the H-ARQ control section 14a of the resend control section 14. Based on the determination result from the H-ARQ response determination section 13a, because the received PHY-PDU was an ACK signal relating to H-ARQ, the H-ARQ control section 14a controls the scheduler 2 such that the next packet (MAC-PDU 2) is sent to the wireless communication terminal PS. As a result, the base station CS sends the next packet (MAC-PDU 2) by means of a predetermined downlink subchannel to the wireless communication terminal PS as PHY-PDU 2 (step T3).

The wireless communication terminal PS receives this PHY-PDU 2 via the reception section 20. The demodulation section 21 demodulates this PHY-PDU 2 and then outputs it to the maximum ratio synthesis section 22. At this time, because the PHY-PDU 2 is not a resend packet, it is input into the CRC detection section 25 via the error correction decoding section 23 without undergoing maximum ratio synthesis.

Here, a case will be assumed in which the CRC detection section 25 performs CRC error detection on the PHY-PDU 2, and a CRC error is detected. The H-ARQ resend request section 26 generates a PHY-PDU indicating a NACK signal relating to H-ARQ, and transmits this NACK signal to the base station CS via the modulation section 34 and the transmission section 35 using an ACK channel (step T4). At this time, in response to a request from the CRC detection section 25, the reception buffer 24 stores the PHY-PDU 2 in which a CRC error was detected. Note that, in this case, the PHY-PDU 2 in which this CRC error was detected is not sent to upper layers such as the PHY-PDU analysis section 27 and the like.

The base station CS receives the NACK signal relating to the H-ARQ from the wireless communication terminal PS via the reception section 10. The PHY-PDU analysis section 13 receives the NACK signal via the demodulation section 11 and the error correction decoding section 12. In this PHY-PDU analysis section 13, the H-ARQ response determination section 13a obtains the result of the analysis of the received PHY-PDU indicating the NACK signal, and determines that this received PHY-PDU is a NACK signal relating to H-ARQ. The H-ARQ response determination section 13a outputs this determination result to the H-ARQ control section 14a of the resend control section 14. Based on the determination result from the H-ARQ response determination section 13a, because the received PHY-PDU was a NACK signal relating to H-ARQ, the H-ARQ control section 14a controls the scheduler 2 such that the packet (MAC-PDU 2) for which a resend request was received from the wireless communication terminal PS is resent in the H-ARQ format. As a result, the base station CS sends the resend packet (MAC-PDU 2) by means of a predetermined downlink slot to the wireless communication terminal PS as a resend PHY-PDU 2 (step T5). Here, the same subchannel, modulation format and encoding rate as those used for the previous PHY-PDU 2 in which the CRC error was detected are used for sending the resend PHY-PDU 2.

The wireless communication terminal PS receives the resend PHY-PDU 2 via the reception section 20. The demodulation section 21 demodulates this resend PHY-PDU 2 and then outputs it to the maximum ratio synthesis section 22. Here, the maximum ratio synthesis section 22 performs maximum ratio synthesis on the resend PHY-PDU 2 and on the previous PHY-PDU 2 in which the CRC error was detected which is currently stored in the reception buffer 24. The maximum ratio synthesis section 22 outputs a maximum ratio synthesis bit string to the error correction decoding section 23 and the reception buffer 24. Here, a case is assumed in which the CRC detection section 25 performs CRC error detection on the maximum ratio synthesis bit string but no CRC error is detected. The H-ARQ resend request section 26 generates a PHY-PDU indicating an ACK signal relating to H-ARQ, and sends this ACK signal to the base station CS via the modulation section 34 and transmission section 35 using an ACK channel (step T6). Meanwhile, the data reconstruction section 28 receives the input of the maximum ratio synthesis bit string of the resend PHY-PDU 2 via the PHY-PDU analysis section 27.

When the base station CS receives the ACK signal from the wireless communication terminal PS, in the same way as in step S3 described above, it sends the next packet (MAC-PDU 3) by means of a predetermined downlink slot to the wireless communication terminal PS as a resend PHY-PDU 3 (step T7). Here, in the same way as in step S4 described above, it is assumed that a CRC error has been detected in the received PHY-PDU 3 and that the wireless communication terminal PS has sent a NACK signal to the base station CS (step T8).

In step T8, a case is assumed in which the communication quality of the ACK channel has deteriorated and the data bits indicating the NACK signal have become inverted, namely, a case in which the NACK signal is misinterpreted as an ACK signal in the base station CS. In this case, in the same way as in step S3 described above, the base station CS sends the next packet (MAC-PDU 4) by means of a predetermined downlink slot to the wireless communication terminal PS as PHY-PDU 4 (step T9).

Next, in the wireless communication terminal PS, because the received PHY-PDU 4 is not a resend packet, it is input into the CRC detection section 25 without undergoing maximum ratio synthesis. Here, a case is assumed in which a CRC error is not detected when the CRC detection section 25 performs CRC error detection on the received PHY-PDU 4. The H-ARQ resend request section 26 generates a PHY-PDU indicating an ACK signal relating to H-ARQ, sends this ACK signal to the base station CS via the modulation section 34 and the resend section 35 using an ACK channel (step T10).

Meanwhile, the data reconstruction section 28 receives the input of the received PHY-PDU 4 via the PHY-PDU analysis section 27. Accordingly, the data reconstruction section 28 at this point has received inputs of four packets, namely, the MAC-PDU 1, the MAC-PDU 2, the MAC-PDU 3 which contains an error, and the MAC-PDU 4. Because of this, if this one group of MAC-PDU is arranged in sequence, it is in a state in which the MAC-PDU 3 has been deleted, namely, a state in which a packet error has occurred.

The data sequence determination section 29 detects packet errors by performing sequence determination for the MAC-PDU of one group, and notifies the MAC-ARQ resend request section 30 about the result of this detection (step T11). When a packet error is detected based on this packet error detection result, the MAC-ARQ resend request section 30 generates a MAC-PDU showing a NACK signal (i.e., a MAC-PDU 3 resend request) relating to MAC-ARQ. The MAC-ARQ resend request section 30 sends the NACK signal relating to the MAC-ARQ to the base station CS via the PHY-PDU construction section 32, the error correction encoding section 33, the modulation section 34, and the transmission section 35 using an ACK channel (step T12).

The base station CS receives the NACK signal relating to the MAC-ARQ from the wireless communication terminal PS via the receiving section 10. The PHY-PDU analysis section 13 receives this NACK signal via the demodulation section 11 and the error correction decoding section 12. In this PHY-PDU analysis section 13, the MAC-ARQ response determination section 13b obtains analysis results of the received PHY-PDU indicating the above described NACK signal, and determines that the received PHY-PDU is a NACK signal relating to MAC-ARQ. The MAC-ARQ response determination section 13b outputs this determination result to the MAC-ARQ control section 14b of the resend control section 14. Based on the determination result from the MAC-ARQ response determination section 13b, because the received PHY-PDU was a NACK signal relating to MAC-ARQ, the MAC-ARQ control section 14b controls the scheduler 2 such that the packet (MAC-PDU 3) for which a resend request was made from the wireless communication terminal PS is resent and MAC-ARQ format (step T13).

In the above described resending in MAC-ARQ format, the scheduler 2 allocates a downlink slot such that the resend timing of the resend packet (i.e., the MAC-PDU 3) is delayed by a predetermined time (specifically, it is made to wait for its turn in the traffic wait queue). Moreover, the bandwidth allocation section 4 allocates a subchannel which is different from the subchannel used for the previous sending of the MAC-PDU 3 to the resend packet. Furthermore, the communication management section 3 allocates a modulation format having a low transmission rate to the resend packet.

As is described above, by delaying the resend timing of the resold packet (MAC-PDU 3), an improvement in the communication quality due to the time lapse (due to a time diversity effect) can be expected. Because of this, there is an improvement in the possibility that the resend packet will be successfully received and that the NACK signal will be successfully received. Moreover, by employing a MAC-ARQ format, it is possible to use a different modulation format from that used during the previous sending of the MAC-PDU 3. Because of this, a modulation format having a low transmission rate (namely, which has superior resistance to any deterioration in communication quality) can be allocated to the resend packet. As a result, it can be reliably expected that the resend packet and the NACK signal will be successful.

Furthermore, by allocating a different subchannel from the subchannel used during the previous sending of the MAC-PDU 3, an improvement in communication quality (due to a frequency diversity effect) can be expected. This contributes to the possibility that the resend packet will be successfully received and that the NACK signal will be successfully received. When a different subchannel from the subchannel allocated during the previous sending of the. MAC-PDU 3 is allocated in this manner, after the base station CS has received a bandwidth allocation request from the wireless communication terminal PS, it is desirable for the base station CS to perform carrier sensing on the uplink, and to give priority allocation to subchannels having high SINR.

Namely, if it is assumed that by controlling the upward transmission output the upward reception level is made the same between users, then it can be thought that the reception level is also the same between subchannels. Accordingly, the interference level can be considered to be low (i.e., the communication quality is good) in subchannels having a high total SINR in each subchannel. As a result of this, subchannels having a high SINR are given priority when subchannels are allocated to resend packets. When measuring SINR, the SINR tabulated in subchannel units is used for the determination without users being aware of it. Moreover, an average value over a fixed period is used for the SINR and old SINR are not used.

In addition, the base station CS constructs a control PHY-PDU to which is attached a physical layer header which includes MAP information showing subchannels for resend packets determined in the manner described above and control information such as encoding rates and modulation formats. The base station CS then sends this control PHY-PDU to the wireless communication terminal PS (step S14).

In the wireless communication terminal PS, the resend format modification detection section 27a obtains the results of the analysis of the control PHY-PDU received in step S14, and detects that the resend control format has changed from H-ARQ to MAC-ARQ. The resend format modification detection section 27a sends a request to the maximum ratio synthesis section 22, the reception buffer 24, the CRC detection section 25, and the H-ARQ resend request section 26 requesting that they move to an operation-halted state (step T15).

Next, when the sending timing of the resend packet (MAC-PDU 3) arrives, the base station CS sends the MAC-PDU 3 (PHY-PDU 3) to the wireless communication terminal PS using the subchannel decided in step S13 and a modulation format having a low transmission rate (step T16). In the wireless communication terminal PS, because the maximum ratio synthesis section 22, the reception buffer 24, the CRC detection section 25, and the H-ARQ resend request section 26 are in an operation-halted state, the received PHY-PDU 3 is input into the data sequence determination section 29 via the PHY-PDU analysis section 27 and the data reconstruction section 28 without undergoing the characteristic processing of the H-ARQ.

Here, if a case is assumed in which the reception of the PHY-PDU 3 was successful and the grouping together of the resent MAC-PDU 3 with the already received MAC-PDU 1, the MAC-PDU 2, and the MAC-PDU 4 was successful, then the data sequence determination section 29 notifies the MAC-ARQ resend request section 30 that no packet error has been detected (step T17). The MAC-ARQ resend request section 30 generates a MAC-PDU showing an ACK signal relating to MAC-ARQ. The MAC-ARQ resend request section 30 sends the ACK signal relating to the MAC-ARQ to the base station CS via the PHY-PDU construction section 32, the error correction encoding section 33, the modulation section 34, and the transmission section 35 using an ACK channel (step T18). The MAC-PDU 1 through MAC-PDU 4 in which there was no packet error and which have been successfully formed into a group and arranged in sequence are input into an upper layer (step T19).

As is described above, according to the wireless communication system of the present embodiment which is formed by a base station CS and wireless communication terminals PS, by initially performing resend control using H-ARQ, a high communication speed and efficient packet error compensation which are the features of H-ARQ are achieved. When communication quality deteriorates and a packet error occurs, a switch is made to resend control using MAC-ARQ and the sending timing of the resend packet is delayed. In addition to this, subchannel modification and a change to a modulation format having a low transmission rate are performed, so that there is an increased chance of successfully receiving the resend packet. As a result, it is possible to prevent the occurrence of packet errors.

Note that in the above described embodiment, when MAC-ARQ is used, the delaying of the sending timing of the resend packet is performed at the same time as the subchannel modification and the change to a modulation format having, a low transmission rate. However, the present embodiment is not limited to this, and because an improvement in communication quality due to time lapse can be expected even when only the delaying of the sending timing is performed, this also is effective towards preventing the occurrence of packet errors. However, in order to more reliably prevent the occurrence of packet errors, as in the above described embodiment, it is desirable for the subchannel modification and the change to a modulation format having a low transmission rate to be performed simultaneously.

Moreover, it is also possible to employ a structure in which, if a packet error occurs during the use of H-ARQ, then MAC-ARQ is not used, but instead resending is conducted by means of H-ARQ with the addition of a time delay. In this type of structure as well, an improvement in communication quality due to time lapse can be expected. However, in this case, because H-ARQ is used for the resending, it is not possible to modify the subchannels and modification format.

Moreover, in the above described embodiment, an example is described a case in which orthogonal frequency division multiple access (OFDMA) is employed in addition to time division multiple access (TDMA) and time division duplex (TDD). However, this wireless communication system is not limited to this and the present invention can also be applied to other wireless communication systems which use H-ARQ for resend control.

### INDUSTRIAL APPLICABILITY

According to the present invention, it is possible to enable an H-ARQ to function normally even when a frequency band is shared by a plurality of wireless communication terminals.

1. A wireless communication system which performs packet communication in a time division multiplexing communication format between wireless communication devices using either one or a plurality of communication channels, comprising:
a resend request unit which detects that a received packet contains an error and requests a resend;
a resend request detection unit which detects the request for a resend;
a packet resend unit which resends the packet in accordance with the request for a resend detected by the resend request detection unit; and
a channel allocation unit which allocates a different communication channel for the packet resend unit to resend the packet from the communication channel which was used for sending the packet in which the error detected by the resend request unit was contained.

2. The wireless communication system according to claim 1, wherein
the communication channel is a subchannel used in an OFDMA system which handles the frequency bands used for communication in subchannel units which are made up of a plurality of subcarriers.

3. The wireless communication system according to claim 2, wherein
the channel allocation unit newly allocates the same number of subchannels for the packet resend unit to resend the packet as the number of subchannels which were used for sending the packet in which the error detected by the resend request unit was contained.

4. The wireless communication system according to claim 3, wherein
the channel allocation unit newly allocates the same number of subchannels for the packet resend unit to resend the packet as the number of subchannels which were used for sending the packet in which the error detected by the resend request unit was contained, and
allocates at least one subchannel which is different from the subchannels which were used for sending the packet in which the error detected by the resend request unit was contained.

5. A wireless communication system which performs packet communication in a time division multiplexing communication format between wireless communication devices using a multicarrier communication system in which frequency bandwidths are adaptively allocated, comprising:
a resend request unit which detects that a received packet contains an error and requests a resend;
a resend request detection unit which detects the request for a resend;
a packet resend unit which resends the packet in accordance with the request for a resend detected by the resend request detection unit; and
a bandwidth allocation unit which allocates the same frequency bandwidth for the packet resend unit to resend the packet as the frequency bandwidth which was used for sending the packet in which the error detected by the resend request unit was contained.

6. A base station device which performs packet communication in a time division multiplexing communication format with a wireless communication terminal using either one or a plurality of communication channels, comprising:
a resend request detection unit which detects a resend request requested by the wireless communication terminal;
a packet resend unit which resends the packet in accordance with the request for a resend detected by the resend request detection unit; and
a channel allocation unit which allocates a different communication channel for the packet resend unit to resend the packet from the communication channel which was used previously for sending the same packet as the packet to be resent.

7. The base station device according to claim 6, wherein
the communication channel is a subchannel used in an OFDMA system which handles the frequency bands used for communication in subchannel units which are made up of a plurality of subcarriers.

8. The base station device according to claim 7, wherein
the channel allocation unit newly allocates the same number of subchannels for the packet resend unit to resend the packet as the number of subchannels which were used previously for sending the same packet as the packet to be resent.

9. The base station device according to claim 8, wherein
the channel allocation unit newly allocates the same number of subchannels for the packet resend unit to resend the packet as the number of subchannels which were used previously for sending the same packet as the packet to be resent, and
allocates at least one subchannel which is different from the subchannels which were used previously for sending the same packet as the packet to be resent.

10. A wireless communication method in which packet communication is performed in a time division multiplexing communication format between wireless communication devices using either one or a plurality of communication channels, comprising:
a resend request step in which it is detected that a received packet contains an error and a resend is requested;
a resend request detection step in which the request for a resend is detected;
a packet resend step in which the packet is resent in accordance with the request for a resend detected in the resend request detection step; and
a channel allocation step in which, when the packet resend unit is resending the packet, a different communication channel is allocated from the communication channel which was used for sending the packet in which the error detected in the resend request step was contained.

11. A wireless communication system which includes first and second wireless communication devices which perform packet communication, comprising:
a first error detection unit which, after performing error correction processing on a received packet received by the first wireless communication device, detects whether or not an error is present in the received packet on which the error correction processing was performed;
a second error detection unit which, after the processing of the first error detection unit, performs a further error detection for the received packet on which the error correction processing was performed;
a resend request unit which, in accordance with the result of the second error detection, requests the second wireless communication device to resend the same packet as the received packet; and
a resend unit which, based on this request, resends the same packet as the received packet from the second wireless communication device.

12. The wireless communication system according to claim 11, wherein the wireless communication system is further provided with a scheduling unit which determines the sending sequence of a transmission packet when this transmission packet is to be resent using the resend unit.

13. The wireless communication system according to claim 11, wherein
the packet communication is conducted in ODFMA format between the first and second wireless communication devices, and
there is further provided a channel allocation unit which, when the same packet as the received packet is to be resent using the resend unit, allocates a different communication channel from the communication channel which was used for sending the same packet as the received packet prior to the resending.

14. The wireless communication system according to claim 11, wherein
the packet communication is conducted in ODFMA format between the first and second wireless communication devices, and
there is further provided a modulation format determination unit which, when the same packet as the received packet is to be resent using the resend unit, selects a different modulation format from the modulation format which was used to send the packet prior to the resending.

15. The wireless communication system according to claim 14, wherein,
when the same packet as the received packet is to be resent using the resend unit, the modulation format determination unit selects a modulation format having a lower transmission rate than that of the modulation format which was used to send the packet prior to the resending.

16. A wireless communication terminal which performs packet communication, comprising:
a first error detection unit which, after performing error correction processing on a received packet, detects whether or not an error is present in the received packet on which the error correction processing was performed;
a second error detection unit which, after the processing of the first error detection unit, performs a further error detection for the received packet on which the error correction processing was performed; and
a resend request unit which, in accordance with the detection result from the second error detection unit, requests the base station to resend the same packet as the received packet.

17. A base station comprising a resend unit which resends the same packet as the received packet in response to the resend request from the wireless communication terminal described in claim 16.

18. The base station according to claim 17, wherein there is further provided a scheduling unit which determines the sending sequence of a transmission packet when this transmission packet is to be resent using the resend unit.

19. The base station according to claim 17, wherein
the packet communication is conducted in ODFMA format between this host base station and the wireless communication terminal, and
the base station is further provided with a channel allocation unit which, when the same packet as the received packet is to be resent using the resend unit, allocates a different communication channel from the communication channel which was used for sending the same packet as the received packet prior to the resending.

20. The base station according to claim 17, wherein
the packet communication is conducted in ODFMA format between this host base station and the wireless communication terminal, and
the base station is further provided with a modulation format determination unit which, when the same packet as the received packet is to be resent using the resend unit, selects a different modulation format from the modulation format which was used to send the packet prior to the resending.

21. The base station according to claim 20, wherein,
when the same packet as the received packet is to be resent using the resend unit, the modulation format determination unit selects a modulation format having a lower transmission rate than that of the modulation format which was used to send the packet prior to the resending.

22. A wireless communication method in which packet communication is performed between first and second wireless communication devices, comprising:
a first step in which, error correction processing is performed on a received packet received by the first wireless communication device, and a detection is made as to whether or not an error is present in the received packet on which the error correction processing was performed;
a second step in which, after the first step, a further error detection is made for the received packet on which the error correction processing was performed;
a third step in which, in accordance with the result of the error detection of the second step, a request is made to the second wireless communication device to resend the same packet as the received packet; and
a fourth step in which, based on this request, the same packet as the received packet is resent from the second wireless communication device.

23. A wireless communication system which includes first and second wireless communication devices which perform packet communication, comprising:
a first error detection unit which, after performing error correction processing on a received packet received by the first wireless communication device, detects whether or not an error is present in the received packet on which the error correction processing was performed;
a second error detection unit which, after the processing of the first error detection unit, performs a further error detection for the received packet on which the error correction processing was performed;
a resend request unit which, in accordance with the result of the second error detection, requests the second wireless communication device to resend the same packet as the received packet;
a channel allocation unit which allocates a different communication channel from the communication channel which was used to send the packet which the resend request unit requested be resent; and
a resend unit which, based on this resend request, resends the same packet as the received packet from the second wireless communication device using the communication channel allocated by the channel allocation unit.
